(19) United States
(12) Patent Application Publication
(10) Pub. No.: US 2026/0352672 A1
(43) Pub. Date: Nov. 5, 2026

(54) ANALYZE USER PLANE NETWORK TRAFFIC IN CLOUD ENVIRONMENT

(71) Applicant: TELEFONAKTIEBOLAGET LM ERICSSON (PUBL), Stockholm (SE)

(72) Inventors: Anders Hansén, Seoul (KR); Michael Lundkvist, Stockholm (SE)

(21) Appl. No.: 19/101,994

(22) PCT Filed: Aug. 12, 2022
(86) PCT No.: PCT/IB2022/057575

§ 371 Date: Feb. 7, 2025

(51) Int. Cl. H04L 9/40

(52) U.S. Cl. CPC H04L 63/1408; H04L 63/0428

(57) ABSTRACT

A method performed by a computer system for use in inspecting user plane network traffic in a cloud environment is described. The method includes deploying a temporary container in an executing container group, the executing container group including an application container that executes a packet-processing application, wherein the temporary container includes a network traffic inspection software that includes a pre-compiled network traffic inspection program and configuration information, wherein the temporary container, when deployed, executes a client component that is operable to: establish a secure connection to a server component of the packet-processing application and transfer the network traffic inspection software to the packet-processing application using the secure connection, wherein the pre-compiled network traffic inspection program, when executed in the packet-processing application, is operable to inspect network traffic associated with the packet-processing application.

### BACKGROUND

Cloud radio access network (RAN) refers to a cloud implementation of RAN functionality. For example, certain RAN functionality may be implemented by containers (e.g., Docker® containers) executing in a cloud environment. Cloud RAN allows communications service providers (CSPs) to have increased flexibility, faster delivery of services, and greater scalability in their networks.

A telecommunications architecture typically consists of three integral components: the user plane; control plane; and management plane. The user plane carries the network traffic for users. The user plane in a cloud deployment has rigorous performance requirements (e.g., in terms of latency and jitter). The network stacks of popular operating systems such as Linux® introduce too much latency for processing user plane network traffic. One way to address this problem is by bypassing the Linux kernel networking stack and instead pulling packets directly from a network interface card (NIC) to a custom user space network stack. This may be done using a user space packet-processing framework such as the Data Plane Development Kit (DPDK®).

DPDK is an open-source software project managed by the Linux Foundation that allows for realizing low latency user plane functions in telecommunication networks. DPDK includes a set of user space libraries and drivers that can be used to accelerate packet-processing workloads. In a cloud environment, DPDK based applications may be deployed using containers.

Extended Berkeley Packet Filter (eBPF) is a technology for executing pre-compiled code in the Linux kernel's just-in-time (JIT) virtual machine. An eBPF program may be loaded from user space into Linux kernel space and may be used for analyzing and filtering network traffic.

DPDK version 18.05 added support for executing eBPF programs in a user space DPDK application. In addition, DPDK provides an eBPF library that allows applications to load and unload pre-compiled eBPF executable and linkable (ELF) binaries.

### SUMMARY

A method performed by a computer system for use in inspecting user plane network traffic in a cloud environment is disclosed. The method includes deploying a temporary container in an executing container group, the executing container group including an application container executing a packet-processing application, wherein the temporary container includes a network traffic inspection software that includes a pre-compiled network traffic inspection program and configuration information, wherein the temporary container, when deployed, executes a client component that is operable to: establish a secure connection to a server component of the packet-processing application and transfer the network traffic inspection software to the packet-processing application using the secure connection, wherein the pre-compiled network traffic inspection program, when executed in the packet-processing application, is operable to inspect network traffic associated with the packet-processing application.

A non-transitory machine-readable storage medium that provides instructions that, if executed by a processor of a network device, causes the network device to carry out operations for use in inspecting user plane network traffic in a cloud environment is disclosed. The operations include deploying a temporary container in an executing container group, the executing container group including an application container executing a packet-processing application, wherein the temporary container includes a network traffic inspection software that includes a pre-compiled network traffic inspection program and configuration information, wherein the temporary container, when deployed, executes a client component that is operable to: establish a secure connection to a server component of the packet-processing application and transfer the network traffic inspection software to the packet-processing application using the secure connection, wherein the pre-compiled network traffic inspection program, when executed in the packet-processing application, is operable to inspect network traffic associated with the packet-processing application.

### BRIEF DESCRIPTION OF THE DRAWINGS

The invention may best be understood by referring to the following description and accompanying drawings that are used to illustrate embodiments of the invention. In the drawings:

FIG. 1 is a diagram showing a cloud environment in which user plane network traffic can be inspected, according to some embodiments.

FIG. 2 is a diagram showing a deployment/call flow and a network traffic flow, according to some embodiments.

FIG. 3 is a diagram showing a temporary container, according to some embodiments.

FIG. 4 is a diagram showing an application container, according to some embodiments.

FIG. 5 is a diagram showing a container group, according to some embodiments.

FIG. 6 is a diagram highlighting certain features that provide security/trust for network traffic inspection, according to some embodiments.

FIG. 7 is a flow diagram of a method for use in inspecting network traffic in a cloud environment, according to some embodiments.

FIG. 8 is a flow diagram of a method performed by a client component of a temporary container, according to some embodiments.

FIG. 9 is a flow diagram of a method performed by a server component of a packet-processing application, according to some embodiments.

FIG. 10 is a flow diagram of a method performed by a NTIP, according to some embodiments.

FIG. 11 is a flow diagram of a method for use in inspecting user plane network traffic in a cloud environment, according to some embodiments.

FIG. 12 is a diagram showing an example of a communication system, according to some embodiments.

FIG. 13 is a diagram showing a network node, according to some embodiments.

FIG. 14 is a block diagram showing a virtualization environment in which functions implemented by some embodiments may be virtualized.

### DETAILED DESCRIPTION

The following description describes methods and apparatus for inspecting user plane network traffic in a cloud environment. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Existing cloud RAN counter and log frameworks require that counter definitions, logs, and obfuscation algorithms are defined at build time. For this reason, runtime updates are limited to changes such as increasing log levels and/or enabling debug counters. Therefore, allowing third party (e.g., operator and/or vendor) automation and/or optimization applications to, in a secure manner, dynamically extract traffic information from an executing user plane system is unfeasible.

Embodiments are described herein that allows a user to safely and securely insert (and detach) a temporary program into a networking stack of a packet-processing application (e.g., an application that implements functionality of a cloud RAN component) to inspect/monitor network traffic associated with the packet-processing application. The program may take the form of a network traffic inspection program (NTIP) that is based on eBPF technology. The NTIP and its associated configuration information may be referred to as network traffic inspection software (NTIS).

A NTIP may be inserted (and removed) dynamically without altering the system state. When inserted, the NTIP may access and use an application's sub-system(s) such as packet flow, logging, and counter mechanisms. The NTIP's access may be controlled by an access control list (ACL). The NTIP may be inserted post release (e.g., while the packet-processing application is being executed), which gives the option of designing and deploying a custom program that inspects specific packet types. End-to-end security may be achieved by embedding an obfuscation algorithm and/or encryption keys into the NTIP or its associated configuration information.

An embodiment is a method for use in inspecting network traffic in a cloud environment. The method includes deploying a temporary container in an executing container group, the executing container group including an application container executing a packet-processing application, wherein the temporary container includes a network traffic inspection software that includes a pre-compiled network traffic inspection program and configuration information, wherein the temporary container, when deployed, executes a client component that is operable to: establish a secure connection to a server component of the packet-processing application and transfer the pre-compiled network traffic inspection software to the packet-processing application using the secure connection, wherein the pre-compiled network traffic inspection program, when executed in the packet-processing application, is operable to inspect network traffic associated with the packet-processing application. Additional embodiments and details are described/provided herein below with reference to the accompanying figures.

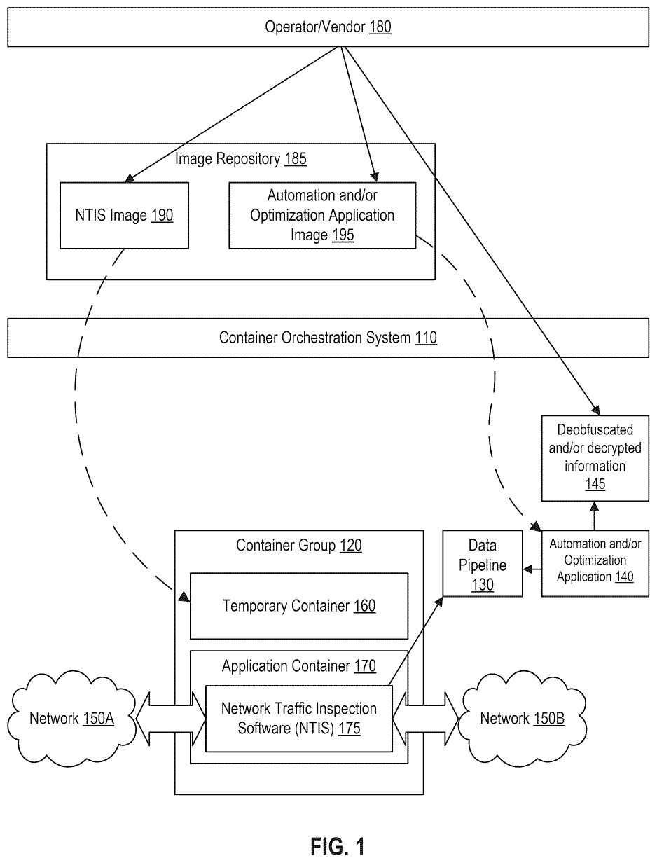

FIG. 1 is a diagram showing a cloud environment in which user plane network traffic can be inspected, according to some embodiments. As shown in the diagram, the environment includes an operator/vendor 180, an image repository 185, a container orchestration system 110, a container group 120, networks 150A and 150B, a data pipeline 130, and an automation and/or optimization application 140.

The operator/vendor 180 may be an entity that operates a mobile network and/or provides equipment/services for implementing a mobile network (or other type of network).

The operator/vendor 180 may want to temporarily monitor certain network traffic (e.g., Internet Control Message Protocol (ICMP) network traffic) being passing its mobile network between network 150A and network 150B and obtain log messages and/or traffic counters related to such network traffic. The network traffic might contain sensitive information so the operator/vendor 180 may want the log messages and/or traffic counters to be obfuscated.

Embodiments are described herein that allow the operator/vendor 180 (or other entity/user) to insert a NTIS 175 into a packet-processing application that is being executed by an application container 170 to monitor/inspect certain network traffic being received and/or sent by the packet-processing application and generate information regarding that network traffic (e.g., in the form of log messages and/or traffic counters) in a secure/trustworthy manner.

In an embodiment, the operator/vendor 180 generates an NTIS image 190. The NTIS image 190 may include a NTIP and its associated configuration and dependencies. During NTIP installation the NTIP may be attachable to a packet-processing framework (e.g., a user space packet-processing framework such as DPDK®) of the packet-processing application being executed by the application container 170 to inspect network traffic associated with the packet-processing application (e.g., network traffic being sent to/from the packet-processing application). The NTIP may be configured to identify certain network traffic associated with the packet-processing application, generate information regarding that network traffic, cause the information to be obfuscated and/or encrypted, and provide the obfuscated/encrypted information to a system. For example, the NTIS image 190 may include a NTIP that is built to identify ICMP network traffic sent/to from a packet-processing application, generate log messages and/or traffic counters related to the ICMP network traffic, cause the log messages and/or traffic counters to be obfuscated/encrypted, and provide the obfuscated/encrypted log messages and/or traffic counters to the data pipeline 130. Encryption can be performed in the NTIP itself or offloaded to the packet-processing application. If offloaded, the NTIP may call a pre-defined packet-processing application helper function to perform encryption. An encryption key may be passed to the helper function as a parameter or temporarily installed into a key store (that is accessible by the helper function) during execution of the NTIP. The encryption key may be deleted when the NTIP is uninstalled.

The data pipeline 130 may be a system that can gather data from multiple sources and provide an analysis and/or visualization of that data. In an embodiment, the data pipeline 130 is an operations, administration, and management (OAM) system (e.g., an OAM of a mobile network).

In an embodiment, the operator/vendor 180 generates an obfuscation algorithm and/or encryption key and incorporates the obfuscation algorithm and/or the encryption key into the NTIP (or NTIS 175) to allow the NTIP to perform obfuscation and/or encryption. In an embodiment, the NTIP is an eBPF program. The operator/vendor 180 may store the NTIS image 190 in the image repository 185.

In an embodiment, the operator/vendor 180 generates an automation and/or optimization application image 195. The automation and/or optimization application image 195 may include an automation and/or optimization application 140 and its associated dependencies. The automation and/or optimization application 140 may include a deobfuscation algorithm (corresponding to the obfuscation algorithm incorporated into the NTIS 175) and/or a decryption key (corresponding to the encryption key incorporated into the NTIS 175). The automation and/or optimization application 140 may be configured to obtain obfuscated/encrypted information generated by the NTIP, deobfuscate/decrypt the obfuscated/encrypted information, and provide the deobfuscated/decrypted information 145 to a user/system for consumption. For example, the automation and/or optimization application 140 may be configured to obtain obfuscated/encrypted log messages and/or traffic counters (e.g., related to the ICMP network traffic sent to/from a packet-processing application) generated by the NTIP, deobfuscate/decrypt the obfuscated/encrypted log messages and/or traffic counters (using the deobfuscation algorithm and/or decryption key), and provide the deobfuscated/decrypted log messages and/or traffic counters to the operator/vendor 180 (e.g., by making the log messages and/or traffic counters accessible to the operator/vendor 180). In an embodiment, the automation and/or optimization application 140 is a RAN automation application. RAN automation may replace manual RAN-related tasks with automated and/or optimization functionality driving down operational costs, using intelligent machine-learning-based functionality. The operator/vendor 180 may store the automation and/or optimization application image(s) 195 in the image repository 185.

The container orchestration system 110 may be a system that can automatically deploy, scale, and manage containerized applications in the cloud environment. In an embodiment, the container orchestration system 110 is a Kubernetes® system or a similar system. The container orchestration system 110 may deploy a container group 120 to be executed in the cloud environment. A container group 120 may include a group of one or more containers that are deployed as a logical unit. In an embodiment, the container group 120 is a Kubernetes® pod. As shown in the diagram, the container group 120 includes an application container 170. The application container 170 may execute a packet-processing application (e.g., that processes network traffic sent between network 150A and network 150B). In an embodiment, the packet-processing application is a user space packet-processing application such as a DPDK® based application. In an embodiment, the packet-processing application implements functionality of a cloud RAN component.

In an embodiment, the operator/vendor 180 uses the container orchestration system 110 (e.g., a graphical user interface (GUI) provided by the container orchestration system 110) to deploy a temporary container 160 in an executing container group 120 (the container group 120 that includes the application container 170 executing a packet-processing application). In an embodiment where the container orchestration system 110 is a Kubernetes® system, the temporary container 160 may be an ephemeral container. In Kubernetes®, an ephemeral container is a special type of container that runs temporarily in an existing pod. In an embodiment, the temporary container 160 is derived from a digitally signed image (e.g., the NTIS image 190) and the container orchestration system 110 verifies the digitally signed image before deploying the temporary container 160 in the executing container group 120.

The temporary container 160 may include the NTIS 175. When deployed in the already executing container group 120, the temporary container 160 may establish a secure connection to the application container 170 within the container group 120 and transfer the NTIS 175 (including the NTIP and the associated configuration information) to the packet-processing application being executed by the application container 170 using the secure connection. The configuration information included in the NTIS 175 may include deployment/attachment details such as DPDK port and queue, direction (Rx/Tx), program type (DPDK mbuf (message buffers) or JIT), and/or ACL information. In an embodiment, the secure connection may be a Transport Layer Security (TLS) connection through a loopback interface (e.g., a Linux® localhost interface).

Upon transfer of the NTIS 175 from the temporary container 160 to the packet-processing application, the NTIP included in the NTIS 175 may be attached to the packet-processing framework of the packet-processing application (e.g., using the configuration information included in the NTIS 175) so that the NTIP can identify certain network traffic associated with the packet-processing application, generate information regarding that network traffic, cause the information to be obfuscated and/or encrypted, and provide the obfuscated/encrypted information to another system. In the example shown in the diagram, the NTIP sends the obfuscated/encrypted information to the data pipeline 130. In an embodiment, a packet-processing framework (e.g., a user space packet-processing framework such as DPDK®) verifies the NTIP (e.g., to ensure that it is safe to be executed) before the NTIP is attached to the packet-processing framework of the packet-processing application. In an embodiment, the packet-processing application configures an ACL for the NTIP (e.g., using the configuration information included in the NTIS 175). The ACL may indicate which functions/APIs the NTIP is allowed to call (an allowlist approach) or which functions/APIs the NTIP is not allowed to call (a denylist approach). The packet-processing application may use the ACL to prevent the NTIP from making unauthorized function calls.

In an embodiment, the operator/vendor 180 uses the container orchestration system 110 (e.g., a GUI provided by the container orchestration system 110) to deploy an automation and/or optimization application 140. When deployed, the automation and/or optimization application 140 may obtain the obfuscated/encrypted information generated by the NTIP, deobfuscate/decrypt the obfuscated/encrypted information (the automation and/or optimization application 140 may have the deobfuscation/decryption materials needed to perform the deobfuscation/decryption), and provide the deobfuscated/decrypted information 145 to a user/system for consumption. In the example shown in the diagram, the automation and/or optimization application 140 obtains the obfuscated/encrypted information generated by the NTIP from the data pipeline 130, deobfuscates/decrypts the information to generate deobfuscated/decrypted information 145, and makes the deobfuscated/decrypted information 145 accessible to the operator/vendor 180 for consumption. Although the diagram shows the automation and/or optimization application 140 as being external to the data pipeline 130, in some embodiments, the automation and/or optimization application 140 is integrated as part of the data pipeline 130.

In an embodiment, the temporary container 160 may cause the application container 170 to detach the NTIP from the packet-processing application (uninstall the NTIP) once the objectives of the NTIP have been met.

Thus, a temporary container 160 may be deployed into an executing container group 120 in the manner described above to transfer a NTIS 175 to an application container 170 using a secure connection. The NTIP included in the NTIS 175 may be attached to a packet-processing framework of a packet-processing application being executed by the application container 170 to inspect network traffic associated with the packet-processing application. The NTIP may generate information regarding the inspected network traffic (e.g., in the form of log messages and/or traffic counters) and provide it to a system/user for consumption. Various security/trust measures such as obfuscation/encryption incorporated into the NTIP/NTIS, digital signature verification (to verify the temporary container 160 before it is deployed), establishment of a secure connection between the temporary container 160 and the application container 170, verification of the NTIP (to ensure that it is safe to execute), and/or an ACL (to screen function calls made by the NTIP) may be put in place to make the process secure/trustworthy.

While a particular configuration of components is shown in this diagram and other diagrams, it should be understood that these configurations are provided as examples to help illustrate particular embodiments. It should be understood that different configurations of components can be used to implement the same/similar functionality. It should also be understood that some embodiments will have additional component or omit some of the components. Thus, the configurations shown in the diagrams are to be regarded as illustrative instead of limiting.

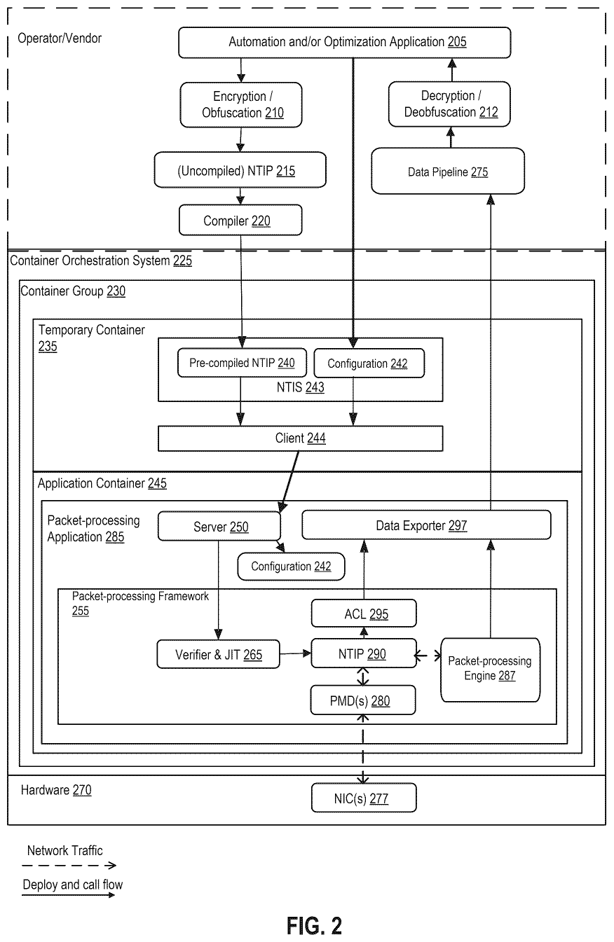

FIG. 2 is a diagram showing a deployment/call flow and a network traffic flow, according to some embodiments. An example deployment/call flow is described herein below with reference to the diagram. As shown in the diagram, the automation and/or optimization application 205 may generate encryption/obfuscation materials 210 (e.g., an obfuscation algorithm and/or an encryption key) and incorporate them into an uncompiled NTIP 215 (e.g., an eBPF program written in C code) such that the NTIP 215 is configured to use those materials 210 to encrypt/obfuscate any network traffic information (e.g., log messages and/or traffic counters) that it generates. A compiler 220 may compile the (uncompiled) NTIP 215 to generate a pre-compiled NTIP 240 (e.g., in the form of a C object file). In an embodiment, the compiler 220 is a low level virtual machine (LLVM) compiler (also referred to as “Clang”). In an embodiment, the automation and/or optimization application 205 generates the uncompiled NTIP 215 (e.g., which could be generic or target specific packets or protocols) and/or the encryption/obfuscation materials 210 (e.g., which could be static, for temporary use, or even for one-time use depending on the security requirements) and causes the compiler 220 to compile the uncompiled NTIP 215. That is, the automation and/or optimization application 205 may automate the generation of the NTIP 215, the generation of the encryption/obfuscation materials 210 to be used by the NTIP 215, and/or the compilation of the NTIP 215. The automation and/or optimization application 205 may also generate configuration information 242 for the NTIP 240. In an embodiment, the automation and/or optimization application 205 may use machine-learning algorithms/techniques to automate one or more of the operations described above. The pre-compiled NTIP 240 and the configuration information 242 may form a NTIS 243.

The container orchestration system 225 may deploy a temporary container 235 (e.g., a Kubernetes® ephemeral container) that includes the NTIS 243 (which includes the pre-compiled NTIP 240 and configuration information 242) and a client component 244 into an executing container group 230 (e.g., a Kubernetes® pod). The client component 244 of the temporary container 235 may establish a secure connection (e.g., an encrypted connection through a loopback interface) to a server component 250 of a packet-processing application 285 (e.g., a user space packet-processing application such as a DPDK® based application) executed by an application container 245. The packet-processing application 285 may execute a server component 250, a data exporter 297, and a packet-processing framework (e.g., a user space packet-processing framework such as DPDK®). The client component 244 of the temporary container 235 may transfer the NTIS 243 to the server component 250 of the packet-processing application 285 using the secure connection. The server component 250 may load the pre-compiled NTIP 240 into the packet-processing framework 255 (e.g., into a secure environment provided by the packet-processing framework 255), load the configuration information 242 into the packet-processing application 285, and attach the pre-compiled NTIP 240 to the packet-processing framework 255 using the configuration information 242 loaded into the packet-processing application 285. A verifier and just-in-time (JIT) component 265 of the packet-processing framework 255 may verify that the pre-compiled NTIP 240 is safe to be executed (e.g., verify that the NTIP 240 does not access memory that it should not, verify that the control flow graph of the NTIP 240 is a directed acyclic graph (DAG), etc.) before attaching the pre-compiled NTIP 240 to the packet-processing framework 255. The verifier and JIT component 265 may perform JIT compilation of the pre-compiled NTIP 240 (e.g., by translating bytecode into the host system's assembly code) for execution. The executing instance of the pre-compiled NTIP 240 is represented in the diagram as NTIP 290. The server component 250 may configure an access control list (ACL) 295 for the NTIP 290 that is used to determine whether certain function calls made by the NTIP 290 are allowed or not. Function calls made by the NTIP 290 may be checked against the ACL 295 to determine whether they are allowed. If a function call is not allowed, it may be blocked and/or reported. The packet-processing framework 255 may be a user space packet-processing framework and/or a kernel space packet-processing framework/stack. Thus, the NTIP 240 may be attached to a user space packet-processing framework and/or a kernel space packet-processing framework/stack depending on the implementation.

An example network traffic flow is now described herein below with reference to the diagram. The poll mode driver(s) (PMD(s)) 280 of the packet-processing framework 255 may obtain network traffic associated with the packet-processing application 285 from the network interface card(s) (NIC(s)) 277 and provide this network traffic to a packet-processing engine 287 of the packet-processing application 285 (e.g., a DPDK® fast path). The NTIP 290 may receive some or all of this network traffic (e.g., packet headers and payloads) depending on configuration (e.g., as ethernet frames or DPDK mbufs). The NTIP 290 may inspect certain parts of this network traffic (e.g., ICMP network traffic coming from a specific source address) and generate information regarding that network traffic (e.g., in the form of log messages and/or traffic counters). The NTIP 290 may cause this information to be obfuscated/encrypted and provide the obfuscated/encrypted information to the data pipeline 275 via a data exporter 297 (e.g., which may be an OAM agent). The NTIP 290 may be allowed to access certain methods/APIs that are part of the packet-processing framework 255 and/or the packet-processing application 285. However, the ACL 295 may be used to prevent the NTIP 290 from calling certain functions/APIs that it is not allowed to call.

The automation and/or optimization application 205 may obtain the encrypted/obfuscated information generated by the NTIP 290 from the data pipeline 275 and decrypt/deobfuscate the encrypted/obfuscated information using decryption/deobfuscation materials 212 (e.g., a deobfuscation algorithm and/or decryption keys). The automation and/or optimization application 205 may provide the decrypted/deobfuscated information to the operator/vendor for consumption. In an embodiment, the NTIP 290 provides the obfuscated/encrypted information to an automation and/or optimization application being executed by the temporary container 235 (not shown) and this automation and/or optimization application decrypts/deobfuscates the encrypted/obfuscated information and provides the decrypted/deobfuscated information to the operator/vendor for consumption.

By way of example only, the diagram shows a single NTIP 290 being deployed and executed in the packet-processing application 285. However, embodiments are not so limited. In some embodiments, more than one NTIP can be deployed and executed simultaneously in the packet-processing application 285. Also, by way of example only, the diagram shows a single temporary container 235 being deployed in the container group 230. However, embodiments are not so limited. In some embodiments, more than one temporary container 235 can be deployed into a container group (e.g., each including a different NTIS). Also, by way of example only, the diagram shows a temporary container 235 that includes a single NTIS 243. However, embodiments are not so limited. In some embodiments, a temporary container 235 can include more than one NTIS.

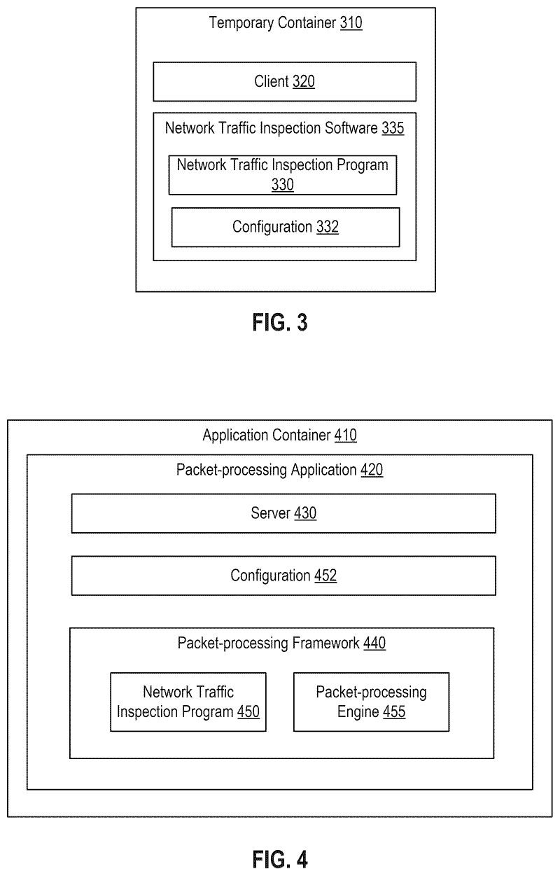

FIG. 3 is a diagram showing a temporary container, according to some embodiments. As shown in the diagram, the temporary container 310 includes a client component 320 and a NTIS 335. The NTIS 335 includes a (pre-compiled) NTIP 330 (e.g., an eBPF program) and associated configuration information 332. The client component 320 may be configured to establish a secure connection to a server component of a packet-processing application to transfer the (pre-compiled) NTIP 330 and associated configuration information 332 to the server component using the secure connection.

FIG. 4 is a diagram showing an application container, according to some embodiments. As shown in the diagram, the application container 410 includes a packet-processing application 420. The packet-processing application 420 includes a server component 430 and a packet-processing framework 440. The server component 430 may be configured to receive a (pre-compiled) NTIP 450 and associated configuration information 452 from a client component of a temporary container (e.g., client component 320), load the configuration information 452 into the packet-processing application 420, and load the NTIP 450 into the packet-processing framework 440. The server component 430 may be further configured to attach the NTIP 450 to the packet-processing framework 440 using the configuration information 452 such that the NTIP 450 is able to inspect network traffic associated with the packet-processing application 420 that is processed by a packet-processing engine 455 of the packet-processing application 420.

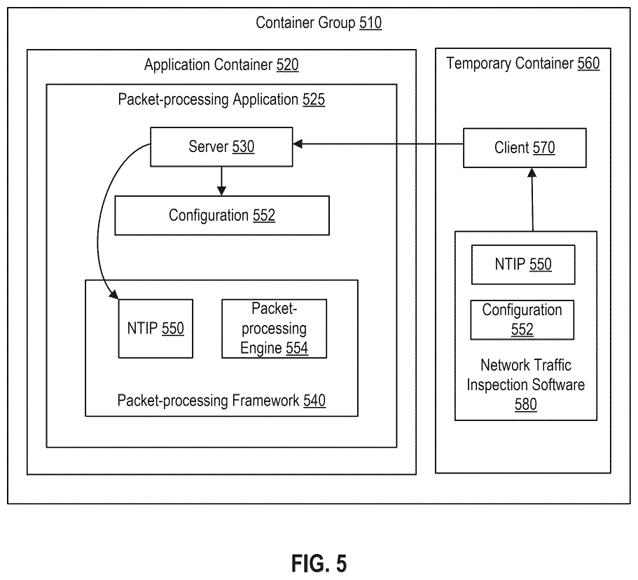

FIG. 5 is a diagram showing a container group, according to some embodiments. As shown in the diagram, the container group 510 includes an application container 520 and a temporary container 560. The application container 520 includes a packet-processing application 525. The packet-processing application 525 includes a server component 530 and a packet-processing framework 540. The packet-processing framework 540 includes a packet-processing engine 554 (e.g., a DPDK® fast path) that processes network traffic (e.g., packets) associated with the packet-processing application. The temporary container 560 includes a client component 570 and a NTIS 580. The NTIS 580 includes a (pre-compiled) NTIP 550 and associated configuration information 552. The client component 570 may be configured to establish a secure connection to the server component 530 and transfer the NTIS 580 (including the (pre-compiled) NTIP 550 and the configuration information 552) to the server component 530 using the secure connection. The server component 530 may be configured to load the NTIP 550 into the packet-processing application 525, load the configuration information 552 into the packet-processing application 525, and attach the NTIP 550 to the packet-processing framework 540 using the configuration information 552 to inspect network traffic associated with the packet-processing application 525 that is processed by the packet-processing engine 554.

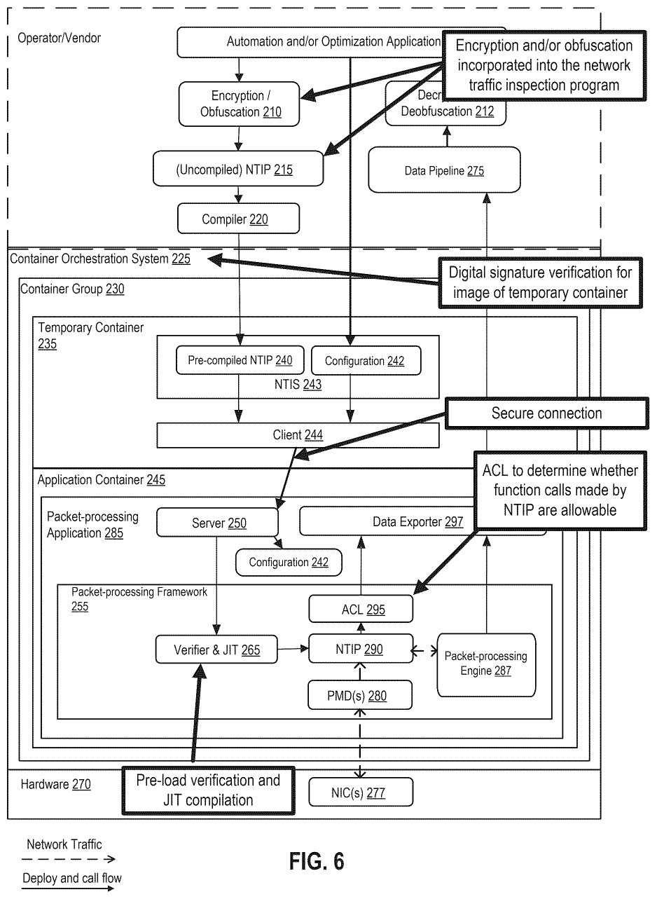

FIG. 6 is a diagram highlighting certain features that provide security/trust for network traffic inspection, according to some embodiments. The features are highlighted in the context of the diagram shown in FIG. 2. As shown in the diagram, obfuscation and/or encryption materials 210 are incorporated into the NTIP 215 to obfuscate and/or encrypt network traffic information generated by the NTIP 215. Also, the temporary container 235 is derived from a digitally signed image that is verified by the container orchestration system 225 before the temporary container 235 is deployed into the executing container group 230. Also, the NTIS 243 (including the pre-compiled NTIP 240 and associated configuration information 242) is transferred from the temporary container 235 to the packet-processing application 285 using a secure connection (e.g., using an encrypted connection through a loopback interface). Also, the pre-compiled NTIP 240 is verified (e.g., that it is safe for execution) before being attached to the packet-processing framework 255 and JIT compilation is performed for safe and efficient execution. Also, the ACL 295 may be used to determine whether function calls made by the executing NTIP 290 are allowed or not (a function call made by the NTIP 290 may be blocked if the ACL indicates that it is not allowed). The highlighted features shown in the diagram and mentioned above may be combined to provide an end-to-end chain of security/trust in the network traffic inspection process.

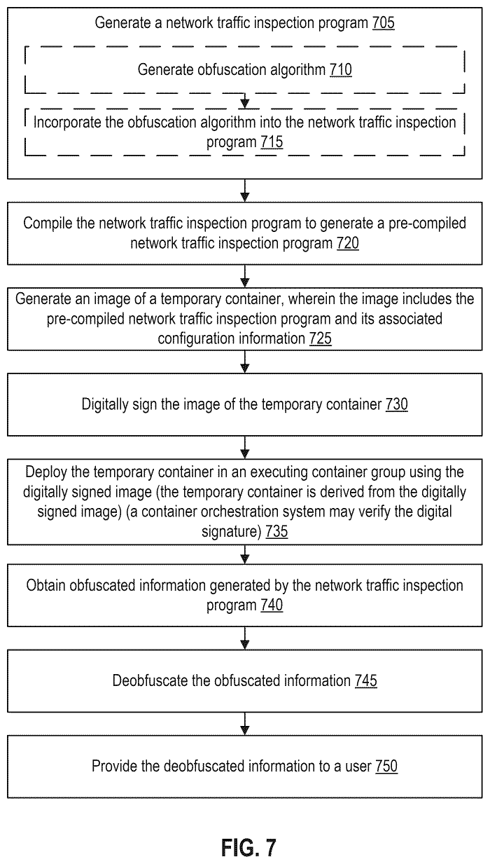

FIG. 7 is a flow diagram of a method for use in inspecting network traffic in a cloud environment, according to some embodiments. The method may be performed by a computer system (e.g., a computer system owned, operated, or controlled by an operator/vendor).

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

At operation 705, the computer system generates a NTIP. In an embodiment, this involves operations 710 and 715. At operation 710, the system generates an obfuscation algorithm. At operation 815, the system incorporates the obfuscation algorithm into the NTIP (e.g., to obfuscate log messages and/or traffic counters generated by the NTIP).

At operation 720, the system compiles the NTIP to generate a pre-compiled NTIP.

At operation 725, the system generates an image of a temporary container, wherein the image includes the pre-compiled NTIP and its associated configuration information.

At operation 730, the system digitally signs the image of the temporary container.

At operation 735, the system deploys the temporary container in an executing container group using the digitally signed image (the temporary container is derived from the digitally signed image). In an embodiment, the digital signature of the image is verified by a container orchestration system before the temporary container is deployed.

At operation 740, the system obtains obfuscated information generated by the NTIP.

At operation 745, the system deobfuscates the obfuscated information.

At operation 750, the system provides the deobfuscated information to a user (or other entity that is to consume the information).

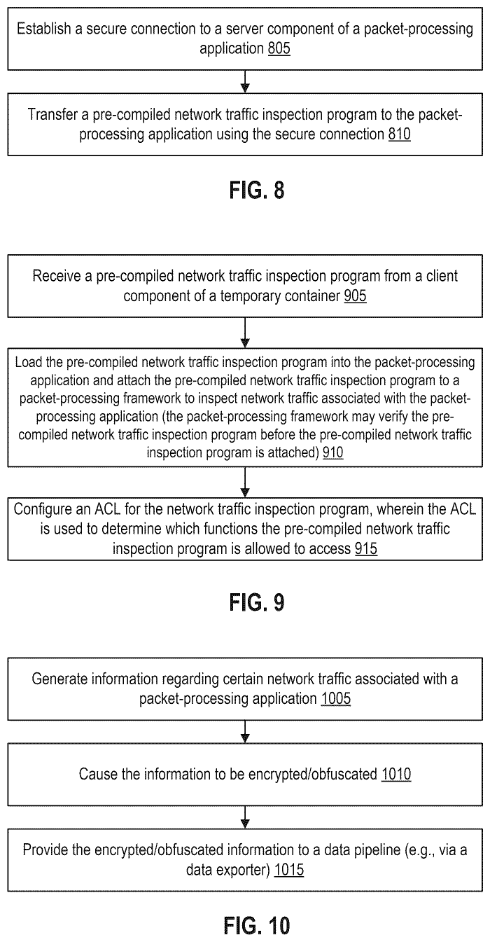

FIG. 8 is a flow diagram of a method performed by a client component of a temporary container, according to some embodiments. The method may be performed after the temporary container has been deployed in an executing container group.

At operation 805, the client component establishes a secure connection to a server component of a packet-processing application (that is executed by an application container that is deployed in the same container group as the temporary container).

At operation 810, the client component transfers a pre-compiled NTIP (and associated configuration information) to the packet-processing application using the secure connection.

FIG. 9 is a flow diagram of a method performed by a server component of a packet-processing application, according to some embodiments. The packet-processing application may be executed by an application container that is deployed in a container group.

At operation 905, the server component receives a pre-compiled NTIP (and associated configuration information) from a client component of a temporary container (that is deployed in the same container group as the application container).

At operation 910, the server component loads the pre-compiled NTIP into the packet-processing application and attaches the pre-compiled NTIP to a packet-processing framework of the packet-processing application (using the configuration information) to inspect network traffic associated with the packet-processing application. In an embodiment, the packet-processing framework verifies the pre-compiled NTIP before the pre-compiled NTIP is attached to the packet-processing application.

At operation 915, the server component configures an ACL for the NTIP, wherein the ACL is used to determine which functions the pre-compiled NTIP is allowed to access. In an embodiment, the packet-processing framework has a mechanism to determine whether functions calls made by the pre-compiled network traffic inspection program are allowable based on the ACL (and possibly block/report any function calls that are not allowed).

FIG. 10 is a flow diagram of a method performed by a NTIP, according to some embodiments.

At operation 1005, the NTIP generates information regarding certain network traffic (e.g., log messages and/or traffic counters related to ICMP network traffic) associated with a packet-processing application.

At operation 1010, the NTIP causes the information to be encrypted/obfuscated.

At operation 1015, the NTIP provides the encrypted/obfuscated information to a data pipeline (e.g., via a data exporter).

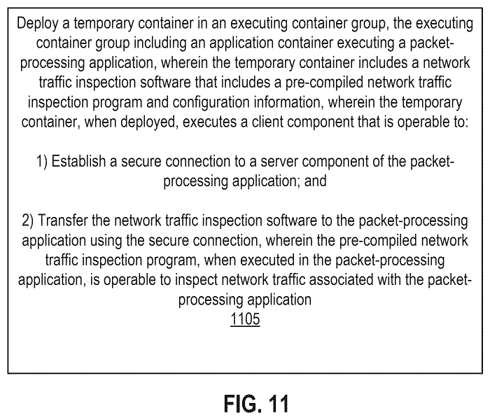

FIG. 11 is a flow diagram of a method for use in inspecting user plane network traffic in a cloud environment, according to some embodiments. The method may be performed by a computer system (e.g., a computer system owned, operated, or controlled by an operator/vendor).

At operation 1105, the computer system deploys a temporary container in an executing container group, the executing container group including an application container executing a packet-processing application, wherein the temporary container includes a network traffic inspection software that includes a pre-compiled network traffic inspection program and configuration information, wherein the temporary container, when deployed, executes a client component that is operable to: 1) establish a secure connection to a server component of the packet-processing application; and 2) transfer the network traffic inspection software to the packet-processing application using the secure connection, wherein the pre-compiled network traffic inspection program, when executed in the packet-processing application (e.g., after being attached to a packet-processing framework using the configuration information), is operable to inspect network traffic associated with the packet-processing application.

In an embodiment, the pre-compiled network traffic inspection program, when executed in the packet-processing application, is further operable to generate information regarding certain network traffic associated with the packet-processing application. In an embodiment, the information regarding the certain network traffic includes one or more of: traffic counters and log messages. In an embodiment, the pre-compiled network traffic inspection program, when executed in the packet-processing application, is further operable to cause the information regarding the certain network traffic to be encrypted or obfuscated and provide the encrypted or obfuscated information to a data pipeline. In an embodiment, the data pipeline is operable to provide the encrypted or obfuscated information to an application that is operable to decrypt or deobfuscate the encrypted or obfuscated information and provide the decrypted or deobfuscated information to a user.

In an embodiment, the pre-compiled network traffic inspection program is verified by a verifier component of a packet-processing framework before the pre-compiled network traffic inspection program is attached to the packet-processing framework of the packet-processing application.

In an embodiment, the temporary container is derived from a digitally signed image, wherein the digitally signed image is verified by a container orchestration system before the temporary container is deployed.

In an embodiment, the secure connection may be an encrypted connection (e.g., a Transport Layer Security (TLS) connection) through a loopback interface.

In an embodiment, the server component of the packet-processing application is operable to configure an ACL for the pre-compiled network traffic inspection program, wherein the ACL is used to determine which functions the pre-compiled network traffic inspection program is allowed to access. In an embodiment, the packet-processing framework has a mechanism to determine whether functions calls made by the pre-compiled network traffic inspection program are allowable based on the ACL.

In an embodiment, the packet-processing application implements functionality of a cloud RAN component. In an embodiment, a RAN automation and/or optimization application is operable to generate a network traffic inspection program and compile the network traffic inspection program to generate the pre-compiled network traffic inspection program. In an embodiment, the RAN automation and/or optimization application is operable to generate an obfuscation algorithm or encryption key and incorporate the obfuscation algorithm or the encryption key into the network traffic inspection software. In an embodiment, the RAN automation and/or optimization application is operable to generate/update the configuration information. In an embodiment, the RAN automation and/or optimization application is operable to reuse an existing network traffic inspection program (instead of generating a new network traffic inspection program).

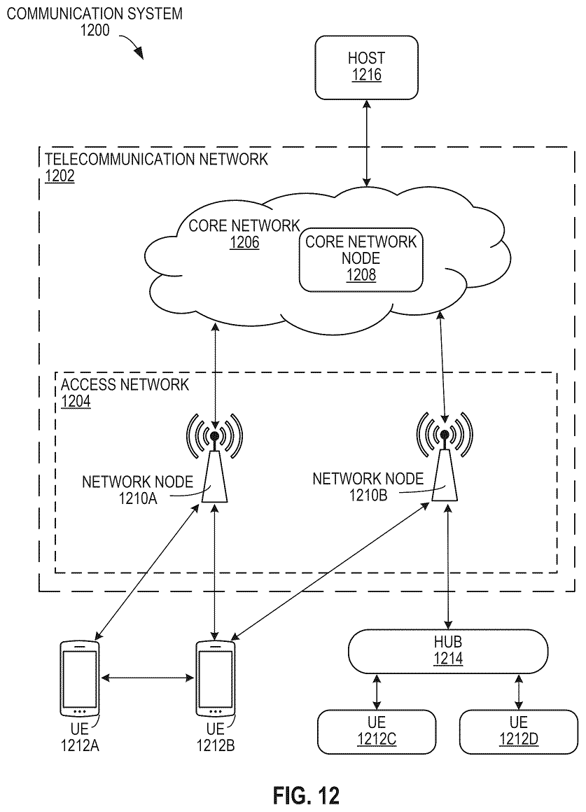

FIG. 12 is a diagram showing an example of a communication system, according to some embodiments.

In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3^{rd} Generation Partnership Project (3GPP) access node or non-3GPP access point. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

In an embodiment, certain functionality of the network nodes 1210 are virtualized (e.g., the functionality is implemented by containers executing as part of a container group). In such embodiments, the techniques described herein may be used to inspect (user plane) network traffic being processed by the network nodes 1210.

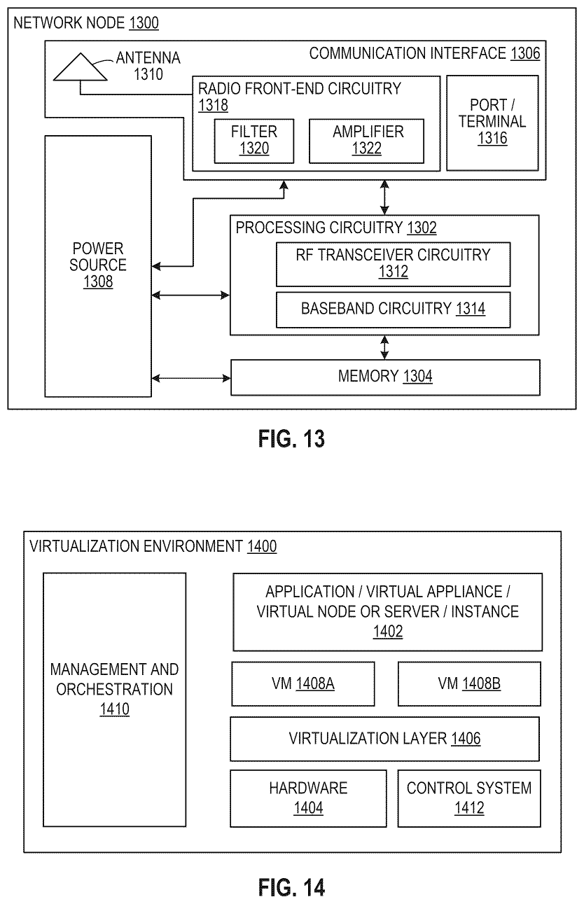

FIG. 13 is a diagram showing a network node, according to some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300. In an embodiment, the network node 1300 is configured to perform one or more of the operations described herein for analyzing/inspecting user plane network traffic in a cloud environment. For example, the memory 1304 may store computer code/instructions that when executed by the processing circuitry 1302, cause the network node 1300 to perform one or more of the operations described herein for analyzing/inspecting user plane network traffic in a cloud environment.

FIG. 14 is a block diagram showing a virtualization environment in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) or containers implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method performed by a computer system for use in inspecting user plane network traffic in a cloud environment, the method comprising:
deploying a temporary container in an executing container group, the executing container group including an application container executing a packet-processing application, wherein the temporary container includes a network traffic inspection software that includes a pre-compiled network traffic inspection program and configuration information, wherein the temporary container, when deployed, executes a client component that is operable to:
establish a secure connection to a server component of the packet-processing application and
transfer the network traffic inspection software to the packet-processing application using the secure connection, wherein the pre-compiled network traffic inspection program, when executed in the packet-processing application, is operable to inspect network traffic associated with the packet-processing application.

2. The method of claim 1, wherein the pre-compiled network traffic inspection program, when executed in the packet-processing application, is further operable to generate information regarding certain network traffic associated with the packet-processing application.

3. The method of claim 2, wherein the information regarding the certain network traffic includes one or more of: traffic counters and log messages.

4. The method of claim 2, wherein the pre-compiled network traffic inspection program, when executed in the packet-processing application, is further operable to cause the information regarding the certain network traffic to be encrypted or obfuscated and provide the encrypted or obfuscated information to a data pipeline.

5. The method of claim 4, wherein the data pipeline is operable to provide the encrypted or obfuscated information to an application that is operable to decrypt or de-obfuscate the encrypted or obfuscated information and provide the decrypted or de-obfuscated information to a user.

6. The method of claim 1, wherein the temporary container is derived from a digitally signed image, wherein the digitally signed image is verified by a container orchestration system before the temporary container is deployed.

7. The method of claim 1, wherein the secure connection is an encrypted connection through a loopback interface.

8. The method of claim 1, wherein the pre-compiled network traffic inspection program is verified by a verifier component of a packet-processing framework before the pre-compiled network traffic inspection program is attached to the packet-processing application.

9. The method of claim 1, wherein the server component of the packet-processing application is operable to configure an access control list (ACL) for the pre-compiled network traffic inspection program, wherein the ACL is used to determine which functions the pre-compiled network traffic inspection program is allowed to access.

10. The method of claim 9, wherein a packet-processing framework has a mechanism to determine whether functions calls made by the pre-compiled network traffic inspection program are allowable based on the ACL.

11. The method of claim 1, wherein the packet-processing application implements functionality of a cloud radio access network (RAN) component.

12. The method of claim 11, wherein at least one of a RAN automation application or RAN optimization application is operable to generate a network traffic inspection program and compile the network traffic inspection program to generate the pre-compiled network traffic inspection program.

13. The method of claim 12, wherein the at least one of RAN automation application or RAN optimization application is operable to generate an obfuscation algorithm or encryption key and incorporate the obfuscation algorithm or the encryption key into the network traffic inspection software.

14. A non-transitory machine-readable storage medium that provides instructions that, if executed by one or more processors of a computer system, causes the computer system to perform the steps of:
deploying a temporary container in an executing container group, the executing container group including an application container executing a packet-processing application, wherein the temporary container includes a network traffic inspection software that includes a pre-compiled network traffic inspection program and configuration information, wherein the temporary container, when deployed, executes a client component that is operable to:
establish a secure connection to a server component of the packet-processing application and
transfer the network traffic inspection software to the packet-processing application using the secure connection, wherein the pre-compiled network traffic inspection program, when executed in the packet-processing application, is operable to inspect network traffic associated with the packet-processing application.

15. The non-transitory machine-readable storage medium of claim 14, wherein the pre-compiled network traffic inspection program, when executed in the packet-processing application, is further operable to generate information regarding certain network traffic associated with the packet-processing application.

16. The non-transitory machine-readable storage medium of claim 15, wherein the pre-compiled network traffic inspection program, when executed in the packet-processing application, is further operable to cause the information regarding the certain network traffic to be encrypted or obfuscated and provide the encrypted or obfuscated information to a data pipeline.

17. The non-transitory machine-readable storage medium of claim 16, wherein the data pipeline is operable to provide the encrypted or obfuscated information to an application that is operable to decrypt or de-obfuscate the encrypted or obfuscated information and provide the decrypted or de-obfuscated information to a user.

18. The non-transitory machine-readable storage medium of claim 14, wherein the temporary container is derived from a digitally signed image, wherein the digitally signed image is verified by a container orchestration system before the temporary container is deployed.

19. The non-transitory machine-readable storage medium of claim 14, wherein the pre-compiled network traffic inspection program is verified by a verifier component of a packet-processing framework before the pre-compiled network traffic inspection program is attached to the packet-processing application.

20. The non-transitory machine-readable storage medium of claim 14, wherein the secure connection is an encrypted connection through a loopback interface.
